(19) United States
(12) Patent Application Publication
(10) Pub. No.: US 2008/0140304 A1
(43) Pub. Date: Jun. 12, 2008

(54) Systems and methods for monitoring and/or controlling traffic

(75) Inventor: Enrico Vaccaro, Dacula, GA (US)

Correspondence Address: MOAZZAM & ASSOCIATES, LLC;MATTERS FOR CINGULAR WIRELESS II, LLC, 7601 LEWINSVILLE ROAD, SUITE 304, MCLEAN, VA, 22102, US

(73) Assignee: Cingular Wireless II, LLC

(21) Appl. No.: 11/585,971

(22) Filed: Oct. 25, 2006

(51) Int. Cl. G08G 1/00

(52) U.S. Cl. 701/117

(57) ABSTRACT

Systems and methods are disclosed for reducing the amount of traffic on the road. These include a communication device in each of a plurality of automobiles sending signals to a central server of each automobile's position and status. The central server then places an icon for each automobile on an interactive map indicating its position and status. The map is then broadcast back to each automobile where the drivers can see the other automobiles on the road. A government agency can also receive the map to control traffic signals in a more effective manner.

### BACKGROUND OF THE INVENTION

1. Field of the Invention

The present invention relates generally to systems and methods for controlling and/or monitoring traffic. More particularly, the present invention relates to systems and methods of detecting the position and other pertinent information about every vehicle in an area for purposes of allowing an individual motorist to avoid heavy traffic and adjusting traffic signal controls for more effective traffic management.

2. Background of the Invention

Driving an automobile, as a major mode of transportation, has become very common in society. There are more cars on the road every day. In all major cities, there exists a constant traffic problem. In some cities, obstructing the flow of traffic is a violation subject to a fine even if one is already going faster than the speed limit allows.

City engineers widen streets, build highways, and fine tune the signaling of traffic all in an effort to improve the flow and increase the efficiency. However, the widened streets and highways attract more motorists. The fine tuning of traffic signals is a tedious and expensive surveying job and the result is merely a timing scheme based on averages.

Maps can give a motorist direction to his or her destination, but maps can be outdated, incorrect, or confusing. GPS navigation systems, such as MAGELLAN, help to curb some of these problems, but still do not guarantee the motorist will follow the directions perfectly. Every missed turn or exit means more time spent on the road, and more time spent on the road means more cars on the road at any given moment.

Public transportation is another attempt at solving the traffic problem.

Most cities have a bus system going to and from preset locations. While this does put many potential drivers all in one vehicle it is still another vehicle on the road, and often a big slower one. Other cities will opt for a subway or metro system. This is viewed as a better system because it keeps traffic off of the streets, but it is very expensive to build and maintain and some cities just can't afford it. No matter how fast or efficient public transportation gets it is still viewed as slow because the bus or subway must stop at each and every stop location to let commuters on and off.

As a city grows it begins to define a “commercial” sector and a “residential” sector. Many people will live in the residential sector and work in the commercial sector. As these two sectors grow over time an individual's commute can be quite distant. And since everyone will commute to work at roughly the same time, and then back to their residence at another time, an exponential amount of traffic is generated at these two times, which is commonly known to many as “rush hour”.

All the while there are emergency vehicles roaming the streets at various times and locations, forcing every car to pull over. Fire trucks responding to fires, police and ambulances responding to emergency and escalating situations. Accidents happen without warning, and cars can stall or break down, blocking one or more precious lanes along an already crowded highway. Roads are constantly being repaired, sometimes during the middle of the day, which may close off a street completely. Natural disaster such as flash floods and falling trees can also block off a road unexpectedly and for undetermined amounts of time.

The media typically handles the job of finding these road blocks and reporting them to the public via radio or television stations. Most automobiles are equipped with radio so the motorists can listen to the traffic reports as they are driving. These reports are often very general though, reporting only extreme traffic situations and only giving a rough estimate as to where the situation is taking place. Some highways have giant LED billboards which can give information to motorists about the wait of traffic, but this information is often given too late for the motorist to choose an alternate direction. Also, these methods do not usually offer a solution such as an alternate route, and when they do, it does not apply to every motorist.

Motorist Assist vehicles also help to curb the problem. These are vehicles that roam the streets looking to help clear the road of stalled cars and recent fender benders. However, these vehicles don't always get to every situation as they rely on communication from a base and their own eyesight, not to mention that the motorist assist vehicle is another car on the road.

There is a need for a system that will give detailed traffic reports that are specific to each motorist. Traffic reports that aren't just mentioning major jams during rush hour, but detailing a specific route from a motorist's starting point to their final destination. But instead of just alerting a motorist to every known hazard and in essence letting him or her know where not to go, this system should also offer a solution particular to their route and tell him or her which routes to take. This system will need to take into consideration the location of every other car on the road on every possible route between the motorist's starting point and destination in order to calculate the optimal path.

GPS units can give a vector, a position and a velocity, for itself, using a satellite system created and maintained by the United States Government. GPS, also known as NAVigation System Timing and Ranging Global Positioning System, or NAVSTAR GPS, has been available for public use since 1996. GPS, when first installed, gave a position accurate up to 15 meters, or 50 feet. Since 2000, a system known as the Wide-Area Augmentation System, or WAAS, has decreased the margin of error to 2 meters, or 6 feet. GPS units have become increasingly popular since their debut. Many new cars come installed with GPS units and some feature navigation systems.

Many new cellular telephones have built-in GPS units for locating in case of emergency. Cellular communication is another area of increasing technology and availability. At the end of 2005, a CTIA study showed that 69% of the United States population subscribed to a cellular telephone service. Cellular telephones work on a network of receiving towers that communicate with a central location. These towers are constantly being built in an effort to create a seamless network across the globe. Not only is this market more popular, but the technology is growing. Cellular companies have now opened data pipelines for delivering broadband internet straight to its customer's phones.

With a system that can determine position in real-time, and a network that can deliver high-speed information, there is a dire need for techniques to combine these systems in an effort to deliver to each and every motorist information specific for that motorist to use to get where the motorist needs to go even faster than conventional methods.

### SUMMARY OF THE INVENTION

The present invention seeks to overcome the shortcomings of present methods by combining these systems and utilizing a technique which can guide motorists through the fastest path to their destination. A communication device, residing in each automobile, will transmit its location and status to the nearest tower. The tower then forwards the data to a database, which will place each automobile on an interactive map in real-time. The map will then be broadcast to the motorist's display screen. The display will show the motorist a map of his area with animated representations of automobiles, emergency vehicles, road blocks, etc. The motorist can also input his destination and request the shortest route from his present location, all things considered.

Furthermore, the present invention will also help the flow of traffic at the government level. The map can be received by a government or agency which will respond by controlling traffic lights. The map can be fed into a software program which controls the traffic lights automatically according to an algorithm, but can have an interface where a person can adjust the controls as well. This will not only help exact traffic signals for maximum traffic efficiency, but can also completely change traffic signals at unexpectedly busy intersections due to changes in traffic from road blocks, road repairs, stalled cars, or natural disasters. Motorist Assistance vehicles will be able to spot stalled cars and fender benders much faster, allowing them to clear the area quickly.

In one particular exemplary embodiment of the present invention, the communication device will be a cellular telephone. This will be particularly useful since cellular telephones have become very common and the technology is relatively inexpensive. The towers that a cellular telephone can communicate with are already in most places as well, which can receive position and status data quickly.

In another exemplary embodiment of the present invention, the map broadcast back to the motorist will be displayed on an in-dash screen inside the automobile. The motorist can view any location at any desired level of zoom. Fast automobiles can be displayed with a green icon, slow automobiles with a yellow icon, and stopped automobiles with a red icon. Black can indicate a stalled vehicle, and a flashing icon can indicate an emergency vehicle. All different types of vehicles can be represented by different icons.

In yet another exemplary embodiment of the present invention, a map is generated featuring boats and ships in the area. Sailors and fisherman carry devices on board their watercrafts to transmit positions and status to a central server for all the other boats and ships in the area to see. This helps the Coast Guard and other rescue teams to find troubled ships.

In yet another exemplary embodiment of the present invention, a map is generated displaying aircrafts in the sky. This map covers a much larger area than for automobiles or boats. Commercial aircrafts generally follow a set flight plan, but independent, recreational aircrafts would greatly benefit from a map displaying and tracking every other aircraft in the area. Aircrafts must keep a constant watch in all 3 dimensions to avoid collision.

In yet another exemplary embodiment of the present invention, a map is generated displaying adventurers such as hikers, rock climbers, skiers, and explorers. This system is mainly used to keep track of a group of people, rather than avoid others, but the same can be utilized. If a detailed map cannot be utilized, a rough topographical map is used as the background. Even if no map is in the background, paths can be found using the locations of others in the area.

### BRIEF DESCRIPTION OF THE DRAWINGS

FIG. 1 shows a diagram of the flow of data as it proceeds from individual vehicles to the database, and back to the vehicles according to an exemplary embodiment of the present invention.

FIG. 2 shows a screen image of an interactive map in an individual vehicle according to an exemplary embodiment of the present invention.

FIG. 3A shows an in-dash screen receiving the interactive map in an automobile according to an exemplary embodiment of the present invention.

FIG. 3B shows a mobile telephone screen receiving the interactive map according to an exemplary embodiment of the present invention.

FIG. 4 shows a screen image of an interactive map on the screen of an adventurer on a ski mountain according to an exemplary embodiment of the present invention.

### DETAILED DESCRIPTION OF THE INVENTION

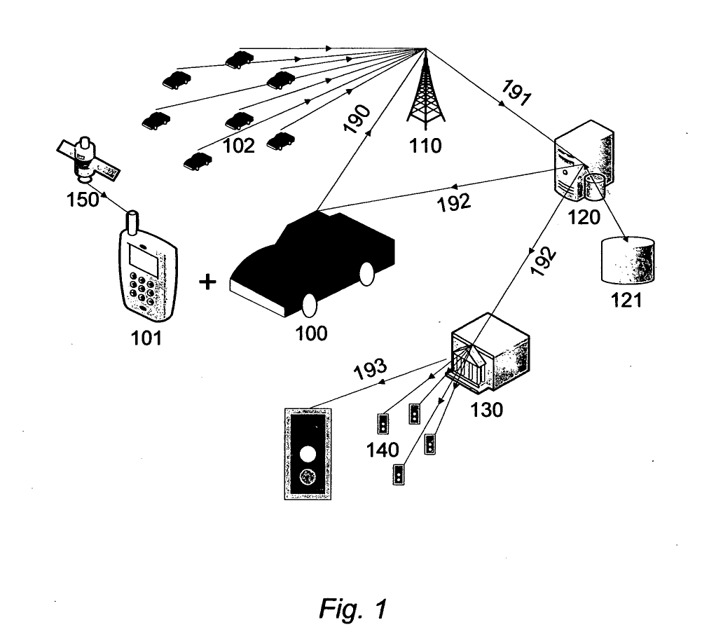

The present invention includes numerous systems and methods. In one exemplary embodiment, the present invention is a system which works by a wireless communication device 101 on board a plurality of automobiles 102 as shown in FIG. 1. Each communication device 101 will be capable of determining its respected automobile's position via an onboard GPS 150 unit.

The status of the automobile 100 will be determined differently depending on the particular elements of the automobile. The speed of the automobile will be read from the onboard GPS unit. Some status elements will be permanent, such as that of a motorcycle, emergency vehicle, or commercial size semi-trailer. Other status elements will be toggled by the user, such as a stalled vehicle, which could be toggled by the hazard lights, oversize load, or trailer attached.

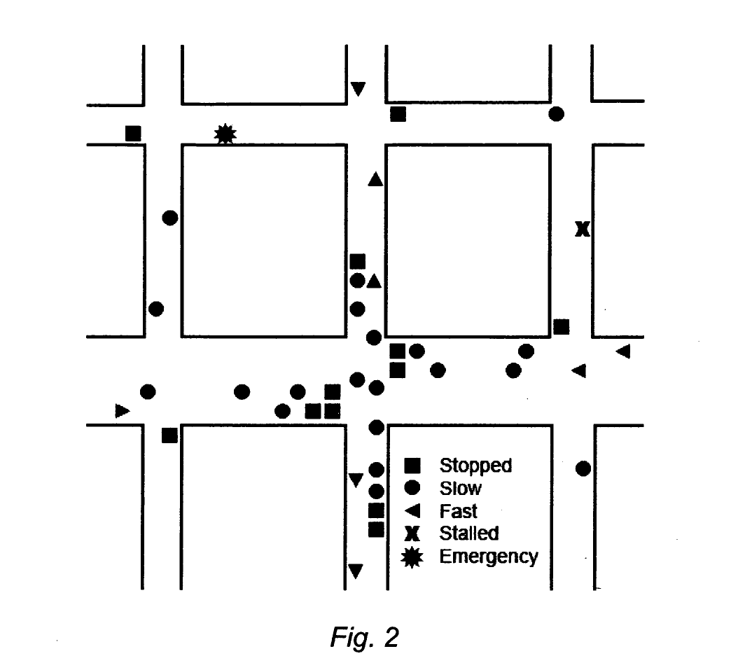

The position and status data is sent 190 from each communication device 101 to a local receiver 100 at a rate determined by a central server 120. The tower 100 then immediately forwards 191 the data onto the server 120 where it is stored in a database 121. A map, as shown in FIG. 2, is then generated from the information in the database 121. This map covers an entire predetermined area such as a whole city. The server 120 places an icon on the map in the location of each automobile on the road FIG. 2. The icon of each automobile can be shaped or color coded according to its status.

In one exemplary embodiment, the speed of the automobile is divided into three steps: fast, slow, and stopped. Fast automobiles are indicated by a green icon, slow automobiles by a yellow icon, and stopped automobiles by a red icon. Such speeds may be predetermined by the system (e.g., fast is defined as over 10 mph over the speed limit) or set by the user. Regular-sized cars, trucks, and vans are displayed by a circular icon, while different automobiles are displayed by different icons, such as a smaller circle for motorcycles, a large rectangle for semi-trailers, and a flashing star for emergency vehicles.

In another exemplary embodiment, suitable for monochrome displays and shown in FIG. 2, all status is represented by the shape of the icon. For example, fast automobiles are indicated by a triangle, slow automobiles by a circle, and stopped automobiles by a square. Motorcycles can be displayed as smaller icons and semi-trailers displayed as larger icons with their speed indicated by shapes similar to regular automobiles. Emergency vehicles can still flash and stalled or hazardous automobiles are displayed as an “X”.

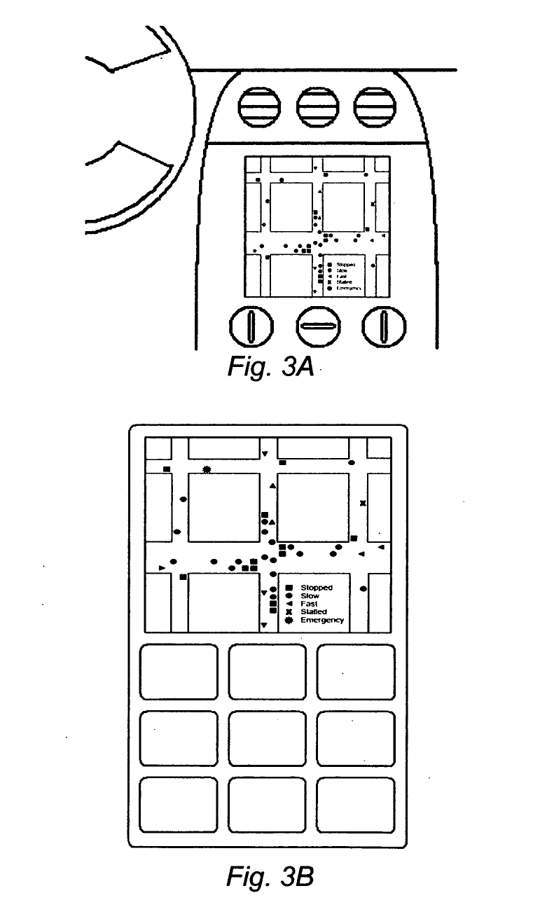

The map is then broadcast 192 and received by motorists 100. The transmission 192 can be received by the communication device 101 and the image displayed on any desired screen in connectivity with the communication device 101. The map can be received by a screen built into the dashboard of the automobile such as that shown in FIG. 3A, or by the motorist's mobile phone such as that shown in FIG. 3B. In one exemplary embodiment, the map is initially displayed with the motorist's automobile icon in the center with the map moving around it. The map also initially zooms to a level where the motorist can clearly see each car around him or her as well as the surrounding streets. The motorist can then choose to zoom out to check the status of major highways or displace the map and zoom in elsewhere to check the status of the motorist's destination. There are many more options for the motorist at this point.

In another exemplary embodiment, the motorist can input his or her destination and request the device to output a shortest route. A software program loaded on the communication device will calculate a shortest route for the motorist upon request. This shortest route can be based on distance, which does not take into consideration other automobiles on the road, or it can be based on time, which considers the amount of cars on every possible route between the motorist's position and destination and their speed. The software program is designed to keep track of the motorist's position with respect to his destination and automatically update the shortest distance when traffic conditions change.

Motorists should not be the only people receiving this broadcast. Others should be able to look at the map of traffic before they get on the road. It would also be very useful for commuters to be able to plan to leave when they see an opportunity when traffic is low. Subscribers can receive the map on a compatible device of their choice. The map can be uploaded to an internet website where anyone can view it through their web browser.

Another body receiving the broadcasted 192 map may be an agency 130 controlling the traffic signals 140. This is most likely, thought not necessarily, a government agency. The agency 130 should have the ability to control every traffic signal 140 from a central location. This location is where the agency 130 will receive the map. Once received, the map is fed into a program to determine how the traffic signals 140 should be controlled in real-time. The program can be integrated with the traffic signal controls to control them automatically. If desired, a human interface can be present for tweaks and changes to the program's control.

In an exemplary embodiment, the program considers the amount of traffic through each intersection and determines the length of green lights based on the flow in each direction. If there is a sudden detour caused by a road block at a major intersection, the program can adjust the signal length for the light of a nearby intersection temporarily to maximize the flow of traffic. If the program detects an emergency vehicle, it can make sure that vehicle hits all green lights from its position to its destination. If the program detects an accident it can send a message to the police and/or hospital alerting them of the situation. If a car is stalled or is otherwise blocking a lane the program can send notice to the nearest motorist assistance vehicle.

A plurality of wireless communication devices aboard boats, ships, and other watercrafts may form their own network, according to another exemplary embodiment of the present invention. Another server may be dedicated to locating and mapping each watercraft and place it on a map. Similar symbols can be used to indicate the status of these watercrafts as are used for automobiles. The map is received through the same methods as well, being through the communication device shown in FIG. 3B, or any device in communication with it, such as a mounted monitor shown in FIG. 3A. Though traffic may not be as easily avoided in a watercraft, the user can still see when there is traffic and when the waters are clear. The user can also use the map to avoid smaller and emergency watercrafts.

A plurality of communication devices aboard aircrafts may form another network according to another exemplary embodiment of the present invention. Another server is dedicated to locating and mapping each aircraft in the sky. The map generated for aircrafts may cover an entire country or a portion thereof, and can be received on the communication device shown in FIG. 3B or any device in connection with it as shown in FIG. 3A. The symbols for aircrafts can be similar to automobiles, but the addition of altitude to the status of aircrafts is very useful. This requires an altimeter, in connection with the communication device, to send a reading of the aircraft's altitude to the receiving tower with each update. Since the symbol indicates the speed a color scheme would work best to represent the altitude. Many commercial aircrafts fly on set trajectories but recreational aircrafts can make good use of this technique to avoid collision with other aircrafts.

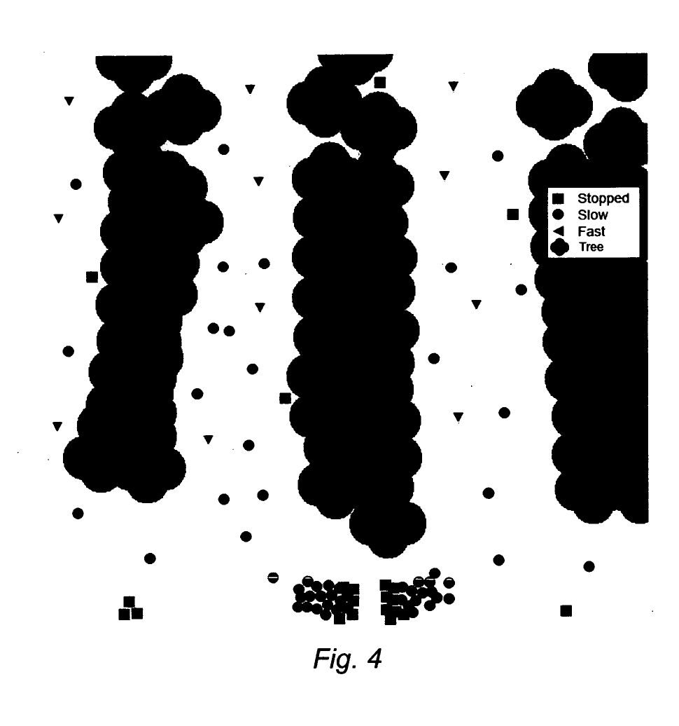

Hikers, rock climbers, skiers, explorers, and high adventurers may form a network of their own according to another exemplary embodiment of the present invention. Yet another server may be dedicated to locating and mapping each and every communication device to recognize the individuals in a given park, mountain, range, or territory. The map, as shown in FIG. 4 for a ski mountain, can be received using the above described devices, but a handheld communication device as shown in FIG. 3B is likely the most convenient map displaying option for an adventurer. Symbols for speed in places other than a ski mountain may not be as necessary in this embodiment, but can be utilized nonetheless. Adventurers may use this technique to locate the most popular trail or the least traveled trail depending on the user's desire. It can also be used to find other members of your group.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of relieving traffic comprising the steps of:
receiving a plurality of wireless signals from a plurality of communication devices in each of a plurality of vehicles containing data indicating a position and a status,
placing an icon for each vehicle on a map indicating the position and status,
refreshing the map with updated positions and status at a pre-determined rate, and
wirelessly broadcasting the map.

2. The method of claim 1, wherein the position and a speed is read by the communication device through an attached or onboard GPS unit.

3. The method of claim 1, wherein the vehicle is an automobile.

4. The method of claim 1, wherein the status of a vehicle includes a plurality of choices including fast, slow, stopped, stalled, emergency vehicle, motorcycle, semi-trailer, altitude, etc.

5. The method of claim 1, wherein the map is displayed on an operator's cellular telephone or a device in connection with the communication device.

6. The method of claim 1, wherein the map, as seen by an operator, has a refresh rate set at the motorist's discretion.

7. The method of claim 1, wherein the icons placed on the map have a color for stopped vehicles, another color for slow vehicles, and another color for fast vehicles, and a shape to indicate other status.

8. The method of claim 1, wherein the map is received by an agency for purposes of controlling a plurality of traffic signals.

9. The method of claim 8, wherein the map received is fed to a software program which controls the traffic signals automatically.

10. The method of claim 1, wherein the vehicle is a watercraft.

11. The method of claim 1, wherein the vehicle is an aircraft.

12. The method of claim 1, wherein the communication device is connected to an altimeter.

13. The method of claim 12, where the altimeter sends a reading of altitude to a receiver with each reception.

14. The method of claim 1 where the icons placed on the map have a color scheme to indicate altitude and various shapes to indicate other status.

15. A method of relieving traffic comprising steps of:
receiving a plurality of wireless signals from a plurality of cellular telephones in each of a plurality of vehicles containing data indicating a position and a status,
placing an icon for each vehicle on a map indicating the position and status,
refreshing the map with updated positions and status at a pre-determined rate, and
wirelessly broadcasting the map.

16. The method of claim 15 where the position and a speed is read by the cellular telephone through an attached or onboard GPS unit.

17. The method of claim 15 where the vehicle is an automobile.

18. The method of claim 15 where the status of a vehicle includes a plurality of choices including: fast, slow, stopped, stalled, emergency vehicle, motorcycle, semi-trailer, altitude, etc.

19. The method of claim 15 where the map is displayed on an operator's cellular telephone or a device in connection with the cellular telephone.

20. A method of locating people and vehicles comprising steps of:
receiving a plurality of wireless signals from a plurality of communication devices containing data indicating a position and a status,
placing an icon for each communication device on a map indicating the position and status,
refreshing the map with updated positions and status at a pre-determined rate, and
wirelessly broadcasting the map.
